(19) United States
(12) Patent Application Publication
(10) Pub. No.: US 2019/0170055 A1
(43) Pub. Date: Jun. 6, 2019

(54) TWO-STROKE ENGINE WITH IMPROVED PERFORMANCE

(71) Applicant: TTI (MACAO COMMERCIAL OFFSHORE) LIMITED, Macau (MO)

(72) Inventor: Ronald J. Hoffman, Iva, SC (US)

(21) Appl. No.: 16/210,172

(22) Filed: Dec. 5, 2018

Related U.S. Application Data
(60) Provisional application No. 62/594,876, filed on Dec. 5, 2017.

(51) Int. Cl. F02B 25/28; F02B 75/02; F01B 1/04; F02B 75/22; F02F 7/00

(52) U.S. Cl. CPC F02B 25/28; F02B 75/02; F01B 1/04; F02B 2075/1808; F02F 7/0012; F02B 2075/025; F02B 75/22

(57) ABSTRACT

A two-stroke engine includes a crankcase. A power cylinder extends from the crankcase. The power cylinder selectively fluidly communicates with the crankcase to scavenge the power cylinder. A power piston is reciprocably disposed in the power cylinder. A compressor cylinder extends from the crankcase. The compressor cylinder selectively fluidly communicates with the power cylinder to introduce a pressurized air/fuel mixture into the power cylinder. A compressor piston is reciprocably disposed in the compressor cylinder.

### CROSS-REFERENCE TO RELATED APPLICATIONS

This application claims the benefit of U.S. Provisional Patent Application No. 62/594,876, filed Dec. 5, 2017, the entire contents of which are hereby incorporated by reference.

### FIELD OF INVENTION

The present disclosure relates to engines, and more particularly to two-stroke engines.

### SUMMARY

In one embodiment, a two-stroke engine includes a crankcase. A power cylinder extends from the crankcase. The power cylinder selectively fluidly communicates with the crankcase to scavenge the power cylinder. A power piston is reciprocably disposed in the power cylinder. A compressor cylinder extends from the crankcase. The compressor cylinder selectively fluidly communicates with the power cylinder to introduce a pressurized air/fuel mixture into the power cylinder. A compressor piston is reciprocably disposed in the compressor cylinder.

In another embodiment, a two-stroke engine includes a crankcase. A first cylinder extends from the crankcase along a first cylinder axis. A first piston is reciprocably disposed in the first cylinder. A second cylinder extends from the crankcase along a second cylinder axis. The second cylinder axis is angled with respect to the first cylinder axis. A second piston is reciprocably disposed in the second cylinder. A conduit selectively fluidly connects the second cylinder with the first cylinder to introduce a pressurized air/fuel mixture into the first cylinder.

Other features and aspects of the disclosure will become apparent by consideration of the detailed description and accompanying drawings.

### BRIEF DESCRIPTION OF THE DRAWINGS

FIG. 1 is a perspective view of an engine according to an embodiment of the invention.

FIG. 2 is a perspective view of an outdoor power tool in which the engine of FIG. 1 may be incorporated.

FIG. 3 is a cross-sectional view of the engine of FIG. 1, with a power piston of the engine illustrated in a top-dead-center position.

FIG. 4 is a cross-sectional view of the engine of FIG. 1, with the power piston illustrated in a position about one hundred ten degrees past top-dead-center.

FIG. 5 is a cross-sectional view of the engine of FIG. 1, with the power piston illustrated in a bottom-dead-center position.

FIG. 6 is a cross-sectional view of the engine of FIG. 1, with the power piston illustrated in a position about two hundred thirty degrees past top-dead-center.

FIG. 7 is a cross-sectional view of the engine of FIG. 1, with the power piston illustrated in a position about two hundred seventy degrees past top-dead center.

FIG. 8 is a cross-sectional view of the engine of FIG. 1, with the power piston illustrated in a position about three hundred degrees past top-dead center.

FIG. 9 is a cross-sectional view of the engine of FIG. 1, with the power piston illustrated in a position about three hundred forty degrees past top-dead center.

FIG. 10 is a cross-sectional view of an engine according to another embodiment of the invention.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

Two-stroke engines (also known as two-cycle engines) are used in a wide variety of applications and are typically less costly and provide more power for a given displacement than four-stroke engines. However, typical two-stroke engines may produce greater hydrocarbon emissions due to unburned fuel escaping with the engine exhaust. Improving the performance of a two-stroke engine may allow for an engine that has lower cost and more power for a given displacement than an equivalent four-stroke engine while potentially reducing the hydrocarbon emissions relative to previous two-stroke engines. Additionally or alternatively, the two-stroke engine may provide more power than traditional two-stroke engines of the same displacement.

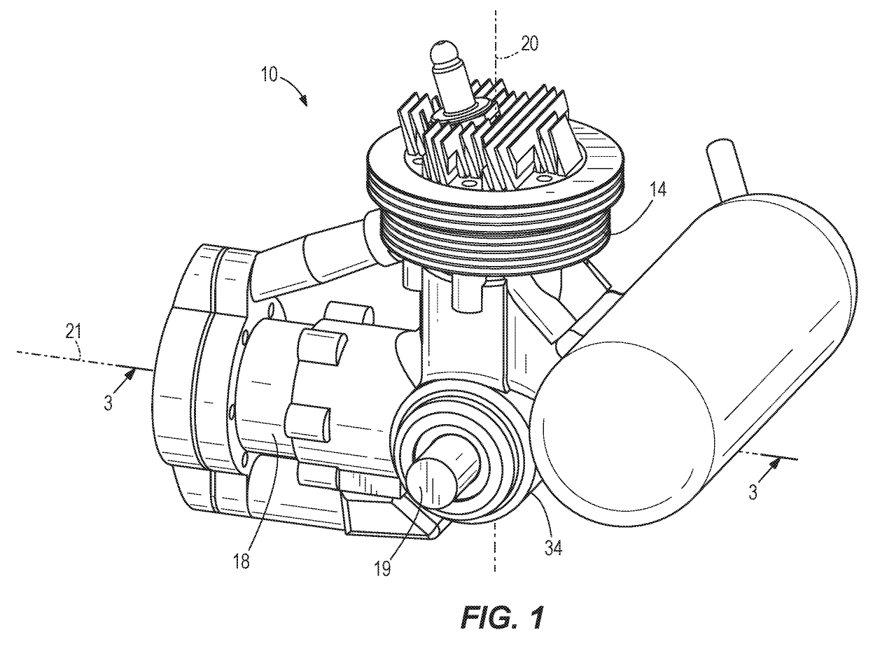

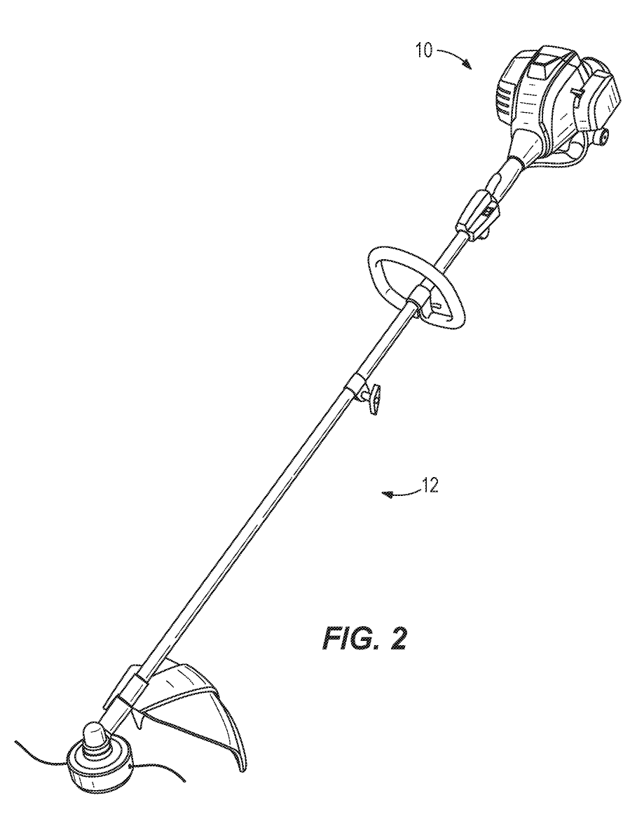

FIG. 1 illustrates an engine 10 according to one embodiment of the invention. The illustrated engine 10 is a compact, two-stroke engine particularly suitable for use with an outdoor power tool, such as a string trimmer 12 illustrated in FIG. 2. The engine 10 may also be used with other types of outdoor power tools (e.g., chainsaws, blowers, etc.), generators, or in any other small engine application.

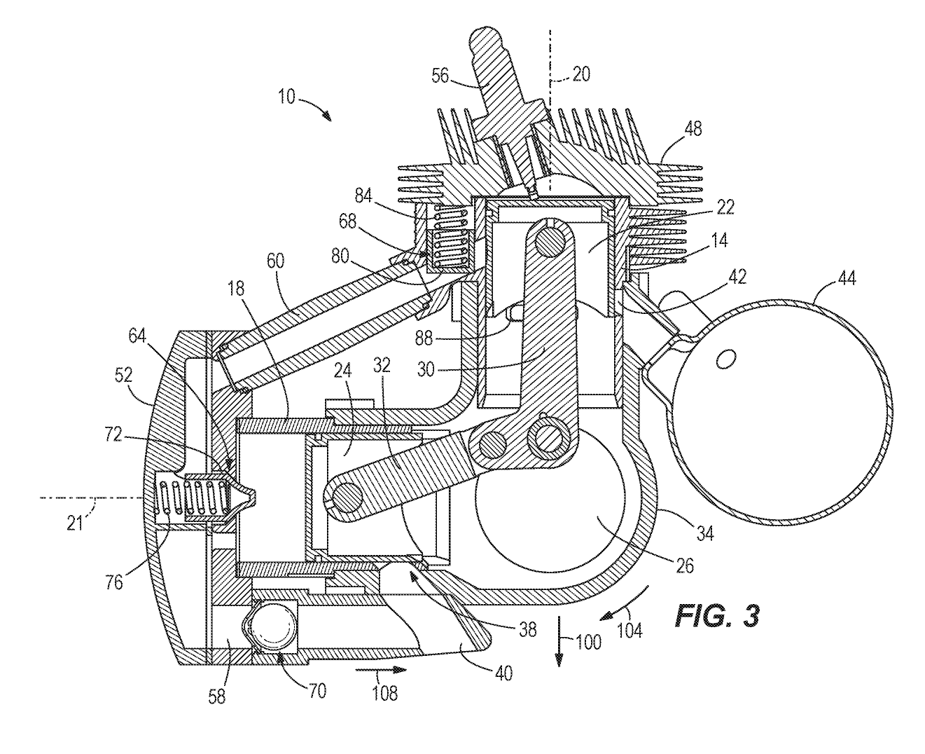

With reference to FIGS. 1 and 3, the engine 10 includes first and second cylinders 14, 18, each defining a respective cylinder axis 20, 21. In the illustrated embodiment, the cylinders 14, 18 are arranged perpendicular to each other in a V-configuration, with the cylinder axes 20, 21 oriented perpendicularly. In other embodiments, the cylinders 14, 18 may have other orientations, including, for example, narrower or wider V-configurations, an in-line configuration, etc. The first cylinder 14 is configured as a power cylinder where an air-fuel mixture is ignited to power the engine 10 and drive an output shaft 19 (FIG. 1). The second cylinder 18 is configured as a compressor cylinder where an air-fuel mixture is compressed before being injected into the power cylinder 14. The compressor cylinder 18 thus acts as a supercharger, increasing the mass flow of air and fuel into the power cylinder 14 and producing a corresponding increase in engine power.

The engine 10 further includes a first piston or power piston 22 received within the power cylinder 14 and a second piston or compressor piston 24 received within the compressor cylinder 18. The pistons 22, 24 are reciprocable within the cylinders 14, 18 along the respective cylinder axes 20, 21. In the illustrated embodiment, the power piston 22 and cylinder 14 have a displacement of about 10 cubic centimeters, and the compressor piston 24 and cylinder 18 also have a displacement of about 10 cubic centimeters. Accordingly, the power piston 22 and cylinder 14 have the same displacement as the compressor piston 24 and cylinder 18. In other embodiments, the power piston 22 and cylinder 14 may have a different displacement than the compressor piston 24 and cylinder 18. In addition, the engine 10 may have a larger or smaller total displacement. The power piston 22 and the compressor piston 24 preferably have the same mass. The V-configuration of the cylinders 14, 18 and the matched masses of the pistons 22, 24 advantageously reduce vibration of the engine 10 during operation.

With continued reference to FIG. 3, the pistons 22, 24 are eccentrically coupled to a crank 26 via respective crank arms 30, 32. The crank 26 is housed within a crankcase 34. The crankcase 34 is located at the base of the cylinders 14, 18 such that the cylinders 14, 18 generally extend from the crankcase 34. The engine 10 further includes an intake port 38 in communication with the crankcase 34 and an exhaust port 42 in communication with the power cylinder 14. The exhaust port 42 is coupled to an exhaust pipe 44 that discharges to the surrounding environment. The exhaust pipe 44 may include a muffler, one or more exhaust treatment elements, and the like. The intake port 38 is coupled to a feed passage 40 that receives a mixture of air and fuel from a carburetor (not shown) or other air/fuel mixing device. This air/fuel mix is supplied into the crankcase 34 through the intake port 38 as described in more detail below.

The power cylinder 14 includes a power cylinder head 48 at an end of the power cylinder 14 opposite the crankcase 34, and the compressor cylinder 18 includes a compressor cylinder head 52 at an end of the compressor cylinder 18 opposite the crankcase 34. An igniter 56 (e.g., a spark plug) extends through the power cylinder head 48 and provides a source of ignition for the air/fuel mix in the power cylinder 14. In the illustrated embodiment, a compressor inlet passage 58 branches off the feed passage 40 and extends through the compressor cylinder head 52. The compressor inlet passage 58 provides air/fuel mix from the feed passage 40 to the compressor cylinder 18 for subsequent compression.

With continued reference to FIG. 3, a connecting passage or conduit 60 extends from the compressor cylinder head 52 to the power cylinder 14. The connecting passage 60 extends through a side wall of the power cylinder 14, just below the head 48. In other embodiments, the connecting passage 60 may connect to the power cylinder 14 through the power cylinder head 48. A first valve 64 selectively permits fluid flow from the compressor cylinder 18 to the connecting passage 60, and a second valve 68 selectively permits fluid flow from the connecting passage 60 to the power cylinder 14. A third valve 70 is included in the compressor inlet passage 58 to selectively permit fluid flow from the feed passage 40 to the compressor cylinder 18. In the illustrated embodiment, the first valve 64, the second valve 68, and the third valve 70 are one-way valves. The first valve 64 includes a first valve member 72 biased toward a closed position by a first spring 76, and the second valve 68 includes a second valve member 80 biased toward a closed position by a second spring 84. The third valve 70 may have a similar configuration. In other embodiments, other types of valves may be used.

The engine 10 further includes transfer ports 88 that are in communication with the crankcase 34 and that extend through a side wall of the power cylinder 14. As described in more detail below, the transfer ports 88 provide crankcase scavenging (i.e. drawing fluid such as air or an air/fuel mixture from the crankcase 34 into the power cylinder 14 to force exhaust out of the cylinder 14 and prime the cylinder 14 for its compression stroke).

The relative positions of the intake port 38, the exhaust port 42, and the transfer ports 88 can be selected to provide a variety of advantages. For example, in the illustrated embodiment, the V-configuration of the engine 10 allows the intake port 38 to be positioned asymmetrically, resulting in asymmetric timing for air/fuel flow into the crankcase 34. In addition, the exhaust port 42 and transfer ports 88 are preferably positioned to minimize the duration that these ports 42, 88 are open, thereby minimizing short-circuiting of non-combusted fuel through the exhaust port 42. In some embodiments, the ports 38, 42, 88 may be positioned so as to provide in-cylinder exhaust gas recirculation (EGR), which may reduce NOx emissions from the engine 10.

Operation of the engine 10 will now be described with reference to FIGS. 3-9. Combustion in the power cylinder 14 begins just before (e.g., about 10-30 degrees before) the power piston 22 reaches a top-dead-center (“TDC”) position illustrated in FIG. 3. With the first and second valves 64, 68 closed and the intake port 38 covered by the compressor piston 24, the igniter 56 ignites an air/fuel mixture that has been compressed to a peak pressure between the top of the power piston 22 and the power cylinder head 48. Once ignited, expanding combustion gases drive the power piston 22 downward toward the crank 26 in the direction of arrow 100. This rotates the crank 26 in the direction of arrow 104, which in turn draws the compressor piston 24 toward the crank 26 in the direction of arrow 108. As the compressor piston 24 moves in the direction of arrow 108, the third valve 70 opens and an air/fuel mixture enters the compressor cylinder 18 via the compressor inlet passage 58.

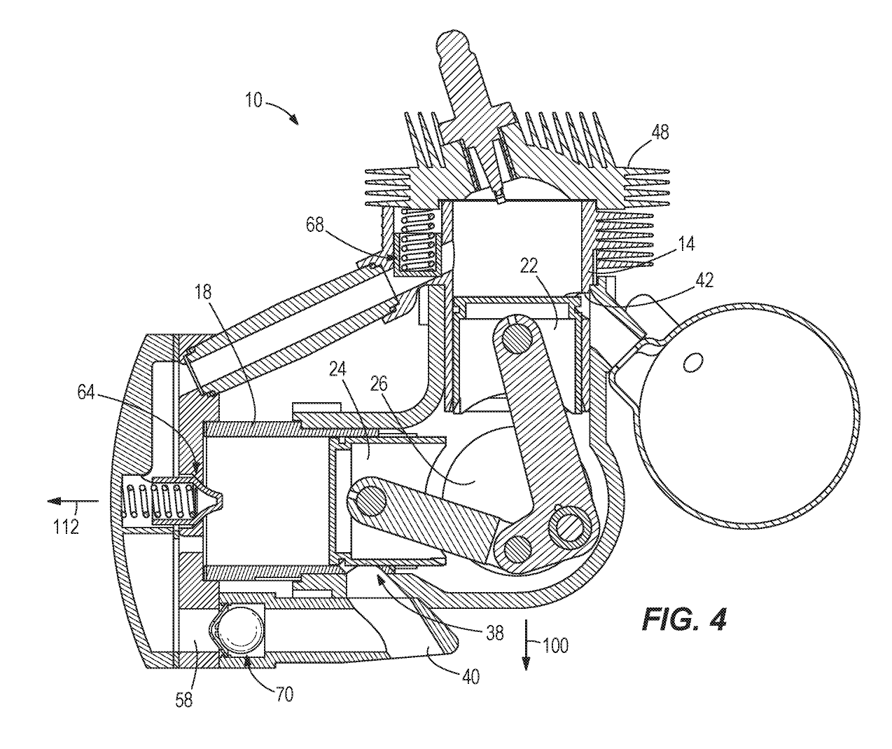

As the pistons 22, 24 both move toward the crank 26, the volume in the crankcase 34 is reduced, compressing an air/fuel mixture in the crankcase 34 to an elevated pressure. The pressure in the crankcase 34 is at or near its maximum when the power piston 22 drops below the exhaust port 42, allowing combustion gases to begin escaping the power cylinder 14 through the exhaust port 42 (FIG. 4). This occurs approximately 110 degrees past the TDC position of the power piston 22 in the illustrated embodiment. At this time, the compressor piston 24 also reverses direction and begins its compression stroke, moving in the direction of arrow 112. The third valve 70 closes as the pressure of the air/fuel mixture in the compressor cylinder 18 begins to rise.

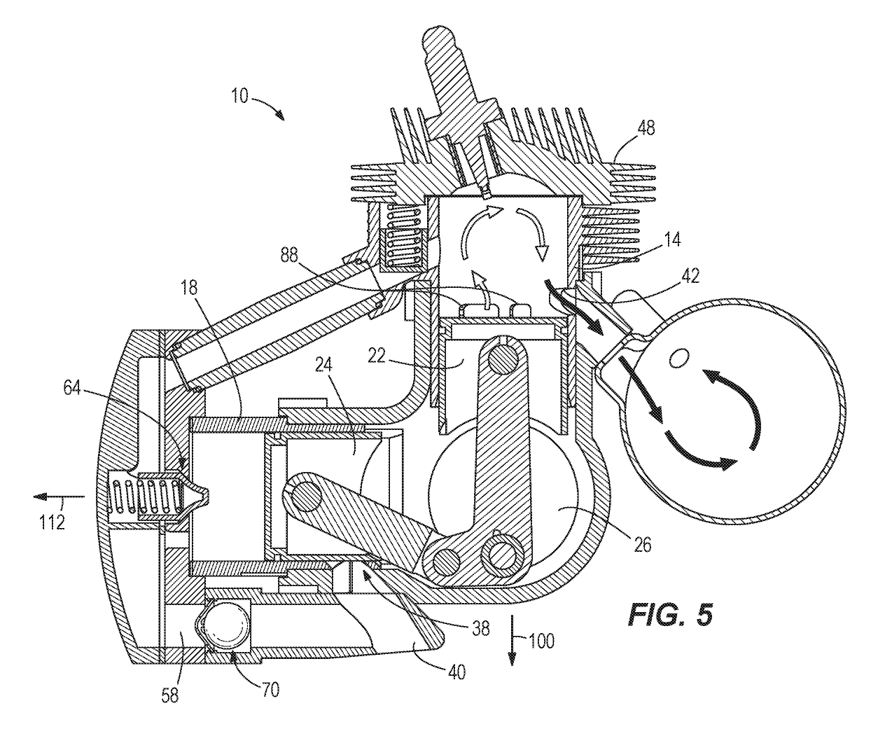

As the power piston 22 continues moving downward toward its bottom-dead-center (“BDC”) position illustrated in FIG. 5, it drops below the transfer ports 88, allowing the pressurized air/fuel mixture from the crankcase 34 to flow through the transfer ports 88 and into the power cylinder 14. The incoming air/fuel mix scavenges the power cylinder 14 by displacing any exhaust still remaining in the power cylinder 14 out through the exhaust port 42. The compressor piston 24 continues moving in the direction of arrow 112, compressing the air/fuel mix in the compressor cylinder 18 while the first and third valves 64, 70 are closed.

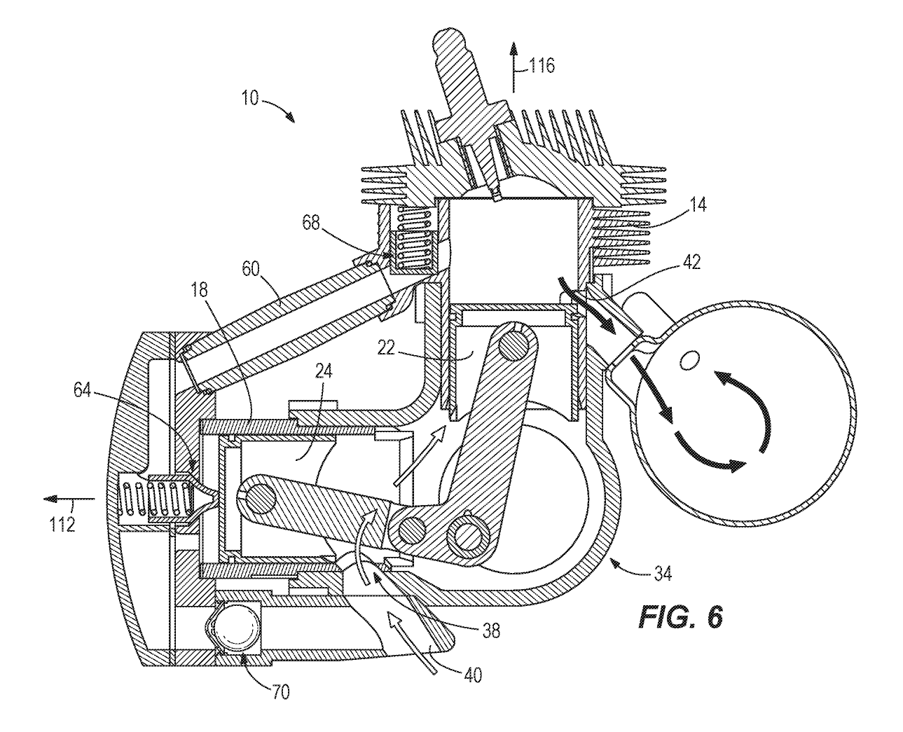

Next, with reference to FIG. 6, the power piston 22 begins moving upward in the direction of arrow 116, completely sealing the transfer ports 88 and beginning to seal the exhaust port 42. In the illustrated embodiment, this occurs at approximately 230 degrees past the TDC position (or approximately 50 degrees past the BDC position). As the compressor piston 24 approaches the end of its compression stroke, it unblocks the intake port 38. An air/fuel mixture flows into the crankcase 34 through the intake port 38 for use in subsequent crankcase scavenging.

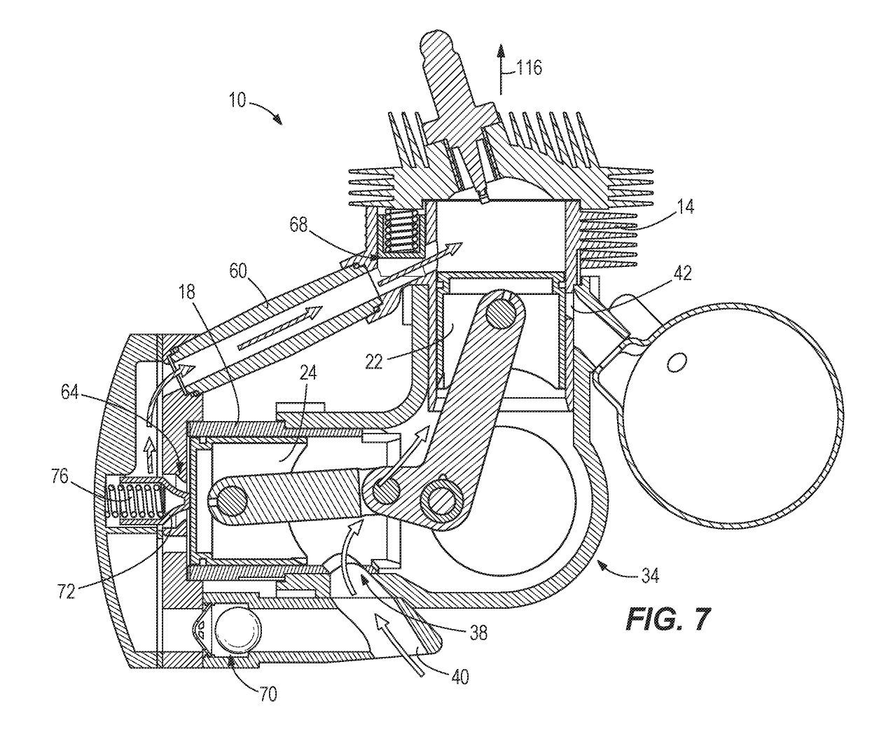

With reference to FIG. 7, the compressor piston 24 reaches the end of its compression stroke at approximately 270 degrees past the power piston's TDC position. By this point, the power piston 22 has sealed the exhaust port 42, and the piston 22 continues moving upward in the direction of arrow 116 to compress the air/fuel mix contained within the power cylinder 14. In the illustrated embodiment, the compressor piston 24 contacts the first valve member 72, displacing it against the force of the first spring 76 and allowing the high pressure air/fuel mixture to flow into the connecting passage 60. This causes the second valve 68 to open, and the high pressure air/fuel mix that was compressed by the compressor piston 24 is injected into the power cylinder 14 during the compression stroke of the power piston 22. Additional air/fuel mixture continues to flow into the crankcase 34 through the intake port 38. In other embodiments, the first valve 64 may open in response to the pressure within the compressor cylinder 18 exceeding a cracking pressure of the first valve 64 such that the piston 24 need not engage the first valve member 72. Because the exhaust port 42 has been closed by the power piston 22, the injected air/fuel mixture cannot escape through the exhaust port 42. This advantageously reduces hydrocarbon emissions. In addition, injecting high pressure air/fuel into the power cylinder 14 before combustion supercharges the engine 10 to produce more power.

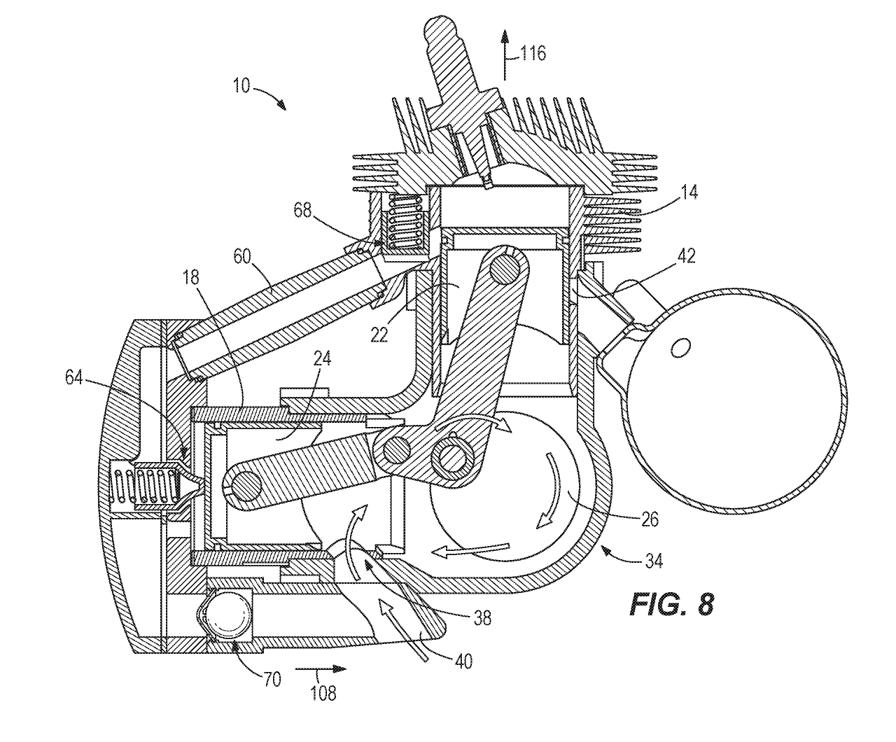

Referring to FIG. 8, the compressor piston 24 begins moving back toward the crank 26 in the direction of arrow 108 when the power piston 22 is at approximately 300 degrees past the TDC position. This allows the first valve 64 to close. The power piston 22 continues moving upward in the direction of arrow 116, further compressing the air/fuel mixture in the power cylinder 14. The piston 22 seals the connecting passage 60, and the second valve 68 also closes in preparation for combustion. Additional air/fuel mixture can continue to enter the crankcase 34 through the intake port 38.

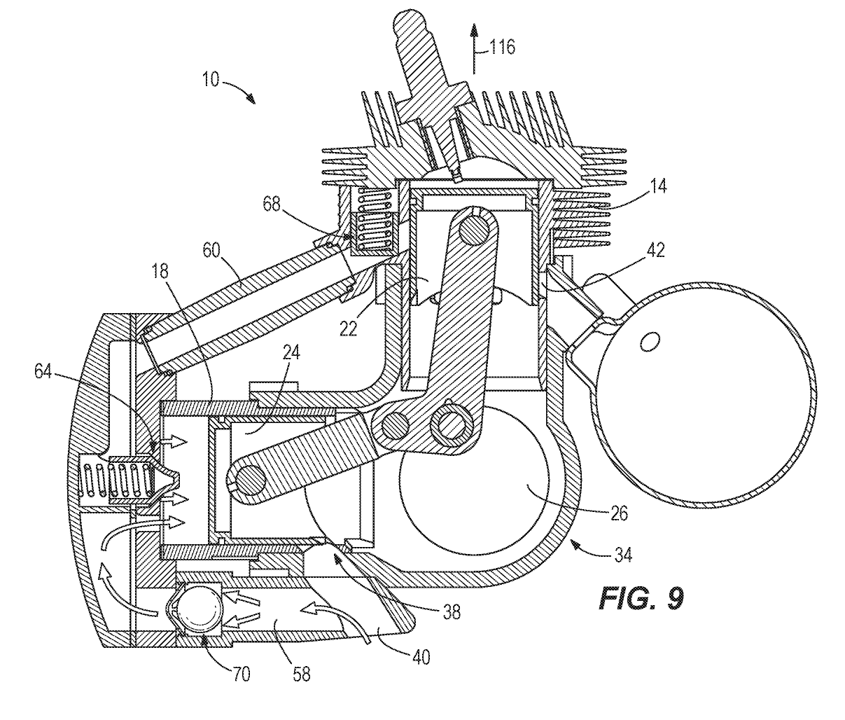

With reference to FIG. 9, just prior to combustion (e.g., at approximately 20 degrees before the TDC position of the power piston 22), the compressor piston 24 is moving in the direction of arrow 108 to draw air/fuel mix into the compressor cylinder 18 through the compressor inlet passage 58. The compressor piston 24 also seals the intake port 38 so that compression of the air/fuel mix in the crankcase 34 may begin. Combustion begins, and the power piston 22 moves to the TDC position described above with respect to FIG. 3. The operating sequence then repeats.

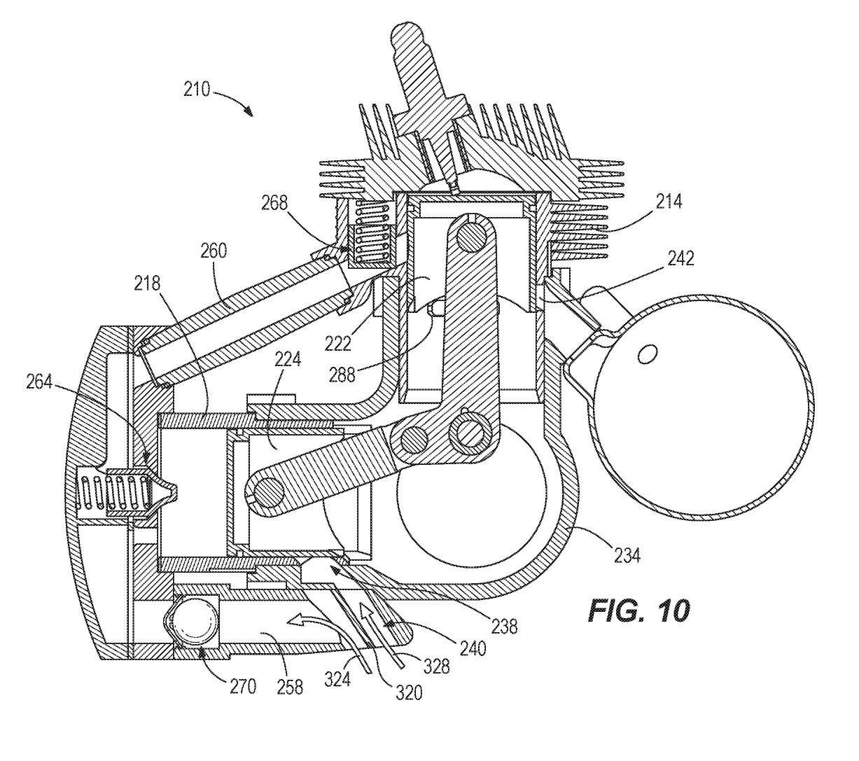

FIG. 10 illustrates an engine 210 according to another embodiment of the invention. The engine 210 is similar to the engine 10 described above with reference to FIGS. 1-9. Accordingly, the following description focuses only on differences between the engine 210 and the engine 10, and features and elements of the engine 210 corresponding with features and element of the engine 10 are given like reference numbers plus “200.”

The engine 210 includes a feed passage 240 provided with a dividing wall 320 that separates the feed passage 240 to provide a first feed path 324 and a second feed path 328. The first feed path 324 communicates with the compressor inlet passage 258, and the second feed path 328 communicates with the crankcase intake port 238. A rich air/fuel mixture is supplied to the compressor cylinder 218 via the first feed path 324, and substantially fuel-free air is supplied to the crankcase 234 via the second feed path 328. Alternatively, substantially fuel-free air may be supplied via the feed passage 240 into both the compressor cylinder 218 and the crankcase 234, or a relatively leaner air/fuel mixture may be supplied via the first feed path 324. In such embodiments, all or additional fuel may be introduced downstream of the compressor cylinder 218 (i.e. between the compressor cylinder 218 and the power cylinder 214). For example, fuel may be injected into the connecting passage 260 to mix with compressed air exiting the compressor cylinder 218. A fuel pump may be provided for this purpose. In some embodiments, an oil pump (not shown) may be provided to introduce oil into the fuel-free air that flows into the crankcase 234 and/or the compressor cylinder 218 for lubrication.

Because there is substantially no fuel in the air drawn into the crankcase 234 of the engine 210 in at least one embodiment, substantially all of the fuel for combustion is supplied to the power cylinder 214 via the compressor cylinder 218. The rich air/fuel mixture from the compressor cylinder 218 combines with additional air in the power cylinder 214 (supplied to the power cylinder 214 from the crankcase 234 during crankcase scavenging) to achieve a proper stoichiometric ratio for combustion. Because the air in the crankcase 234 used for crankcase scavenging is substantially fuel-free, no fuel short-circuits combustion by prematurely exiting through the exhaust port 242. As such, the engine 210 advantageously has reduced hydrocarbon emissions.

Although the disclosure has been described in detail with reference to certain preferred embodiments, variations and modifications exist within the scope and spirit of one or more independent aspects of the disclosure as described. Various features and advantages of the disclosure are set forth in the following claims.

What is claimed is:

1. A two-stroke engine comprising:
a crankcase;
a power cylinder extending from the crankcase, the power cylinder selectively fluidly communicates with the crankcase to scavenge the power cylinder;
a power piston reciprocably disposed in the power cylinder;
a compressor cylinder extending from the crankcase, the compressor cylinder selectively fluidly communicates with the power cylinder to introduce a pressurized air/fuel mixture into the power cylinder; and
a compressor piston reciprocably disposed in the compressor cylinder.

2. The two-stroke engine of claim 1, wherein
the power cylinder includes a sidewall, and
a transfer port is defined in the sidewall, the transfer port selectively fluidly connecting the power cylinder with the crankcase.

3. The two-stroke engine of claim 2, wherein
whether the transfer port fluidly connects the power cylinder with the crankcase depends on a position of the power piston within the power cylinder.

4. The two-stroke engine of claim 3, wherein
an air source selectively fluidly communicates with the crankcase,
the compressor cylinder includes a sidewall, and
an intake port is defined in the sidewall of the compressor cylinder, the intake port selectively fluidly connecting the crankcase with the air source.

5. The two-stroke engine of claim 4, wherein
whether the intake port fluidly connects the crankcase with the air source depends on a position of the compressor piston within the compressor cylinder.

6. The two-stroke engine of claim 5, further comprising
an air/fuel mixture source selectively fluidly communicates with the compressor cylinder.

7. The two-stroke engine of claim 6, wherein
the air/fuel mixture source includes the air source selectively fluidly communicating with the crankcase.

8. The two-stroke engine of claim 1, wherein
a connecting passage selectively fluidly connects the compressor cylinder with the power cylinder.

9. The two-stroke engine of claim 1, further comprising an outdoor power tool powered by the two-stroke engine.

10. A two-stroke engine comprising:
a crankcase;
a first cylinder extending from the crankcase along a first cylinder axis;
a first piston reciprocably disposed in the first cylinder;
a second cylinder extending from the crankcase along a second cylinder axis, the second cylinder axis angled with respect to the first cylinder axis;
a second piston reciprocably disposed in the second cylinder; and
a conduit selectively fluidly connecting the second cylinder with the first cylinder to introduce a pressurized air/fuel mixture into the first cylinder.

11. The two-stroke engine of claim 10, wherein the first cylinder axis and the second cylinder axis are orthogonal to each other.

12. The two-stroke engine of claim 11, wherein the conduit extends along a generally straight line.

13. The two-stroke engine of claim 10, further comprising
an air/fuel mixture source, and
an inlet passage selectively fluidly connecting the second cylinder with the air/fuel mixture source.

14. The two-stroke engine of claim 13, further comprising
a check valve arranged in the inlet passage.

15. The two-stroke engine of claim 10, further comprising
a check valve arranged in the conduit adjacent the second cylinder.

16. The two-stroke engine of claim 15, wherein
the check valve is opened by being compressed by direct contact with the second piston.

17. The two-stroke engine of claim 10, further comprising
a check valve arranged in the conduit adjacent the first cylinder.

18. The two-stroke engine of claim 10, further comprising
a first check valve arranged in the conduit adjacent the second cylinder, and
a second check valve arranged in the conduit adjacent the first cylinder.

19. The two-stroke engine of claim 18, further comprising
an air/fuel mixture source,
an inlet passage selectively fluidly connecting the second cylinder with the air/fuel mixture source, and
a third check valve arranged in the inlet passage.

20. The two-stroke engine of claim 10, further comprising an outdoor power tool powered by the two-stroke engine.
